(19) United States
(12) Patent Application Publication
(10) Pub. No.: US 2026/0222304 A1
(43) Pub. Date: Jul. 30, 2026

(54) METHOD TO IDENTIFY AND MODIFY NWDAF DEPENDENCIES

(71) Applicant: Telefonaktiebolaget LM Ericsson (publ), Stockholm (SE)

(72) Inventors: Konstantinos VANDIKAS, SOLNA (SE); Marin ORLIC, BROMMA (SE); Jaeseong JEONG, SOLNA (SE); Mathieu LECONTE, Verrières-le-Buisson (FR); Illyyne SAFFAR, Le-plessis-Robinson (FR); Oleg GORBATOV, LULEÁ (SE); Attila MITCSENKOV, BUDAPEST (HU); Sabrine AROUA, ANTONY (FR)

(73) Assignee: Telefonaktiebolaget LM Ericsson (publ), Stockholm (SE)

(21) Appl. No.: 19/145,376

(22) PCT Filed: Mar. 24, 2023
(86) PCT No.: PCT/SE2023/050269

§ 371 Date: Jul. 2, 2025

(30) Foreign Application Priority Data
Jan. 30, 2023 (GR) 20230100067

(51) Int. Cl. H04L 41/14; H04L 41/16

(52) U.S. Cl. CPC H04L 41/145; H04L 41/16

(57) ABSTRACT

A computer-implemented method performed by a computing device including a NWDAF having a function to identify and modify dependencies between NWDAFs and at least a first NWDAF consumer. The method includes identifying a relationship between at least the first NWDAF consumer from a plurality of NWDAF consumers that respectively subscribe to the NWDAFs that have respective machine learning, ML, models that have an overlap between a first input feature and respectively have different outputs. At least the first NWDAF consumer uses a first output from the NWDAFs to output an action from the first NWDAF consumer. The method further includes determining whether a second input feature to (i) a respective ML model of the NWDAFs or (ii) a new ML model of an unsubscribed NWDAF can make a positive contribution to the prediction of the output of at least the first NWDAF consumer.

### TECHNICAL FIELD

The present disclosure relates generally to computer-implemented methods performed by a computing device to identify and modify network data analytics function (NWDAF) dependencies, and related methods and apparatuses.

### BACKGROUND

NWDAF is an addition to an existing Network Function (NF) based ecosystem in Third Generation Partnership Project (3GPP) networks. For example, 3GPP TS 23.288 v17.6.0 is directed to architecture enhancements for fifth generation (5G) system (5GS) to support network data analytics services in a 5G core (5GC) network. As discussed in TS 23.288 v17.6.0, the NWDAF is part of the architecture specified in TS 23.501 v17.6.0 and uses the mechanisms and interfaces specified for 5GC in TS 23.501 and operations administration and maintenance (OAM) services. The NWDAF interacts with different entities for different purposes, including, for example:
Data collection based on subscription to events provided by access and mobility management function (AMF), session management function (SMF), policy control function (PCF), unified data management (UDM), network slice access control function (NSACF), application function (AF) (directly or via network exposure function (NEF)) and OAM;
Optionally, analytics and data collection using the Data Collection Coordination Function (DCCF);
Retrieval of information from data repositories (e.g., unified data repository (UDR) via UDM for subscriber-related information;
Optionally, storage and retrieval of information from an Analytics Data Repository Function (ADRF);
Optionally, analytics and data collection from a Messaging Framework Adaptor Function (MFAF);
Retrieval of information about NFs (e.g., from a network repository function (NRF) for network function (NF)-related information);
On demand provision of analytics to consumers, as specified in clause 6 of TS 23.288 v17.6.0, for example.
Provision of bulked data related to analytics ID(s).

If multiple NWDAF instances are deployed, the architecture supports deploying the NWDAF as a central NF, as a collection of distributed NFs, or as a combination of both.

### SUMMARY

There currently exist certain challenges.

The inclusion of NWDAFs in 3GPP may enable more prominence of machine learning (ML) models in networks by harmonizing a process of collecting data needed for a ML model, which presently is expressed in 3GPP as an analytical function to train and produce predictions. The predictions may then be used by other NFs, which allows for a separation of concerns. That is, the NWDAF is tasked only with the maintenance of its corresponding prediction model, while NF associated via a subscription are tasked to perform some action based on a given prediction.

Even though such a clear separation of concerns may be a correct approach from a technical perspective because it avoids overcomplicating the implementation of each function, the approach breaks the concept of a closed loop architecture where essentially the validity of a prediction produced by a NWDAF may be defeated by an action performed by an NF. For example, the validity of a prediction of a NWDAF that predicts congestion may be defeated by an action performed by a NF that fixes the congestion based on the prediction. Since these two functions are split, there may be a time when a prediction is not valid because the predicted congestion was alleviated by an action performed by the NF. This problem may be further exacerbated when dealing with multiple NWDAFs and several NFs acting on their behalf.

While some approaches may try to create and standardize a closed-loop that allows one NWDAF to communicate directly with an NF (and vice-versa), in a large-scale network, for example, identifying which NWDAF is affected by another NF may not be apparent since such functions can be implemented by various vendors. Additionally, such effects may not be directly apparent because two NWDAFs and NFs, for example, may try to solve the same problem but in different ways. In another approach, a feedback mechanism may try to improve correctness of NWDAF analytics; but such an approach may simply result in more data being collected after a particular analytics is produced. In other approaches, a comparison may be performed between predicted outputs of an analytic identifier with a real value, and then an impact on a given key performance indicator (KPI) may be measured for a given action performed by a NF. A problem with such an approach, however, may include that related associations between NWDAFs, NFS, and KPIs would need to be constructed by hand, which can be time consuming, error-prone, expensive, and non-intuitive in a large setup with multiple NWDAFs and NFs, for example.

Certain aspects of the disclosure and their embodiments may provide solutions to these or other challenges.

Embodiments of the present disclosure provide a computer-implemented method that is performed by a computing device comprising a NWDAF having a function to identify and modify dependencies between one or more NWDAFs and at least a first NWDAF consumer. The method comprises identifying a relationship between at least the first NWDAF consumer from a plurality of NWDAF consumers that respectively subscribe to the one or more NWDAFs that have respective ML models that have an overlap between a first input feature to the respective ML models and respectively have different outputs. At least the first NWDAF consumer uses a first output from the one or more NWDAFs to output an action from at least the first NWDAF consumer. The method further comprises determining whether a second input feature to (i) a respective ML model of the one or more NWDAFs or (ii) a new ML model of an unsubscribed NWDAF can make a positive contribution to the prediction of the output of at least the first NWDAF consumer.

In some embodiments, the at least a first NWDAF consumer comprises a NF or an NWDAF.

In some embodiments, the method further comprises performing at least one of (i) requesting that at least the first NWDAF consumer subscribes to the one or more NWDAFs determined to have a second input feature that can make a positive contribution to the prediction of the output of at least the first NWDAF consumer, and (ii) requesting that at least the first NWDAF consumer subscribes to the new ML model of the unsubscribed NWDAF.

In some embodiments, the method further comprises identifying at least the first NWDAF consumer that subscribes to the one or more NWDAFs that have respective ML models that have an overlap between the first input feature and respectively have different outputs.

In some embodiments, the identifying a relationship is based on a relationship graph of at least the first NWDAF consumer that subscribes to the one or more of the NWDAFs that respectively have the first input feature and respectively have different outputs.

In some embodiments, the determining comprises performing an analysis that evaluates a second ML model that uses the first and second input features to associate whether the second input feature of a candidate NWDAF results in the output of the action by at least the first NWDAF consumer; and measuring an importance level of a contribution that the second input feature can make to the prediction of the output of at least the first NWDAF consumer.

In some embodiments, the relationship comprises a relevant relationship and the identifying the relevant relationship includes constructing a graph of relationships between respective NWDAFs from the one or more NWDAFs and at least one of (i) at least the first NWDAF, and (ii) a respective data source from a plurality of data sources that provide the first and second input features to the respective NWDAFs, wherein the graph identifies a relationship between at least one pair of a respective NWDAF and at least the first NWDAF consumer; and iterating over the at least one pair of a respective NWDAF and at least the first NWDAF consumer to build a first ML model that learns to associate whether the first input feature of the respective NWDAF results in the output of the action by at least the first NWDAF consumer.

In some embodiments, the identifying the relevant relationship further comprises building a second ML model comprising the first ML model augmented with the second input feature from a candidate NWDAF in the graph that uses the second input feature as an input to the ML model of the candidate NWDAF, wherein the second ML model learns to associate whether the second input feature of the candidate NWDAF results in the output of the action by at least the first NWDAF consumer.

In some embodiments, determining comprises performing an analysis that evaluates the second ML model to measure an importance level of the contribution that the second input feature of the candidate NWDAF can make to the prediction of the output of at least the first NWDAF consumer

In some embodiments, the importance level is determined based on a comparison of a threshold value to the contribution that the second input feature can make to the prediction of the output of at least the first NWDAF consumer.

In some embodiments, the importance level is based on one of a shapley additive explanations, SHAP, and a local interpretable model-agnostic explanation, LIME, analysis that measures and ranks an importance of the second input feature.

In some embodiments, when the importance level is not satisfied, the requesting includes that at least the first NWDAF consumer subscribes to the new ML model of the unsubscribed NWDAF.

In some embodiments, the method further comprises adding the second machine learning model to the candidate NWDAF.

In some embodiments, when the importance level is satisfied, the requesting comprises that at least the first NWDAF consumer subscribes to the one or more NWDAFs.

In some embodiments, the method further comprises updating the subscription of at least the first NWDAF consumer to add at least one of (i) the one or more NWDAFs and (ii) the new ML model of the unsubscribed NWDAF.

In other embodiments, a computing device is provided. The computing device comprises a NWDAF having a function to identify and modify dependencies between one or more NWDAFs and at least a first NWDAF consumer. The computing device comprises processing circuitry; and memory coupled with the processing circuitry. The memory includes instructions that when executed by the processing circuitry causes the computing device to perform operations. The operations comprise to identify a relationship between at least the first NWDAF consumer from a plurality of NWDAF consumers that respectively subscribe to the one or more NWDAFs that have respective ML models that have an overlap between a first input feature to the respective ML models and respectively have different outputs. At least the first NWDAF consumer uses a first output from the one or more NWDAFs to output an action from at least the first NWDAF consumer. The operations further comprise to determine whether a second input feature to (i) a respective ML model of the one or more NWDAFs or (ii) a new ML model of an unsubscribed NWDAF can make a positive contribution to the prediction of the output of at least the first NWDAF consumer.

In other embodiments, a computing device is provided comprising a NWDAF having a function to identify and modify dependencies between one or more NWDAFs and at least a first NWDAF consumer, where the computing device is adapted to perform operations. The operations comprise to identify a relationship between at least the first NWDAF consumer from a plurality of NWDAF consumers that respectively subscribe to the one or more NWDAFs that have respective ML models that have an overlap between a first input feature to the respective ML models and respectively have different outputs. At least the first NWDAF consumer uses a first output from the one or more NWDAFs to output an action from at least the first NWDAF consumer. The operations further comprise to determine whether a second input feature to (i) a respective ML model of the one or more NWDAFs or (ii) a new ML model of an unsubscribed NWDAF can make a positive contribution to the prediction of the output of at least the first NWDAF consumer.

In other embodiments, a computer program comprising program code is provided to be executed by processing circuitry of a computing device comprising a NWDAF having a function to identify and modify dependencies between one or more NWDAFs and at least a first NWDAF consumer, whereby execution of the program code causes the computing device to perform operations. The operations comprise to identify a relationship between at least the first NWDAF consumer from a plurality of NWDAF consumers that respectively subscribe to the one or more NWDAFs that have respective ML models that have an overlap between a first input feature to the respective ML models and respectively have different outputs. At least the first NWDAF consumer uses a first output from the one or more NWDAFs to output an action from at least the first NWDAF consumer. The operations further comprise to determine whether a second input feature to (i) a respective ML model of the one or more NWDAFs or (ii) a new ML model of an unsubscribed NWDAF can make a positive contribution to the prediction of the output of at least the first NWDAF consumer.

In other embodiments, a computer program product is provided comprising a non-transitory storage medium including program code to be executed by processing circuitry of a computing device comprising a NWDAF having a function to identify and modify dependencies between one or more NWDAFs and at least a first NWDAF consumer, whereby execution of the program code causes the computing device to perform operations. The operations comprise to identify a relationship between at least the first NWDAF consumer from a plurality of NWDAF consumers that respectively subscribe to the one or more NWDAFs that have respective ML models that have an overlap between a first input feature to the respective ML models and respectively have different outputs. At least the first NWDAF consumer uses a first output from the one or more NWDAFs to output an action from at least the first NWDAF consumer. The operations further comprise to determine whether a second input feature to (i) a respective ML model of the one or more NWDAFs or (ii) a new ML model of an unsubscribed NWDAF can make a positive contribution to the prediction of the output of at least the first NWDAF consumer.

Certain embodiments may provide one or more of the following technical advantages. Based on the inclusion of a function that can identify relationships and modify dependencies between one or more NWDAFs and at least a first NWDAF consumer, NWDAF consumer(s) may benefit from a newly produced prediction that may better capture effects of an NWDAF consumer's action. Additionally, improved prediction may avoid re-triggering an action that was the product of an incorrect or inferior prediction. A further technical advantage may include that, based on automatic identification of relationships between NWDAFs/NFs and input features, an amount of time and error in making the identification may be reduced in comparison to, e.g., a manual process.

### BRIEF DESCRIPTION OF DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a block diagram of components of a system in accordance with some embodiments of the present disclosure;

FIG. 2 is a schematic diagram illustrating an example of relationships and potential relationships among NWDAFs and NFs in accordance with some embodiments of the present disclosure;

FIG. 3 is a schematic diagram illustrating an example of relationships and potential relationships among data sources, NWDAFs, and NFs in accordance with some embodiments of the present disclosure;

FIG. 4 is a sequence diagram illustrating operations of an example embodiment in accordance with the present disclosure;

FIG. 5 is a schematic diagram of an overlap of two NWDAFs in accordance with some embodiments of the present disclosure;

FIG. 6 is a flow chart of operations of a computing device in accordance with some embodiments of the present disclosure;

FIG. 7 is a block diagram of a communication system in accordance with some embodiments;

FIG. 8 is a block diagram of a computing device in accordance with some embodiments of the present disclosure; and

FIG. 9 is a block diagram of a virtualization environment in accordance with some embodiments of the present disclosure.

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter.

As used herein, the phrases “network data analytics function” or “NWDAF” refers to, and includes, both NWDAFs and/or NFs; and the phrase “network data analytics function consumer” or “NWDAF consumer” refers to, and includes, both NWDAF consumers and/or NF consumers.

An approach that may address breaks in the concept of a closed loop architecture between NWDAFs/NFs may be to create and standardize a closed-loop that allows one NWDAF to communicate directly with an NF, and vice-versa, thus allowing the NF to directly indicate any invalidation that may occur due to a prediction. A downside with such an approach, however, is that in a large-scale network, for example, identifying which NWDAF is affected by another NF may not be apparent since such functions can be implemented by various vendors. Additionally, such effects may not be directly apparent. Two NWDAFs and NFs, for example, may try to solve the same problem but in different ways. A first NWDAF/NF, for example, may try to handover a set of user equipment (UEs) to another radio base station within coverage to improve coverage; while at the same time, a second NWDAF/NF pair may throttle traffic to alleviate congestion. In this example, essentially, the first NWDAF/NF pair may treat congestion indirectly by moving a UE to another part of the network thus resulting in decongestion.

In one approach, a feedback mechanism may be included to try to improve correctness of NWDAF analytics. See e.g., number 6 discussed in https://www.3gpp.org/ftp/tsg_sa/WG2_Arch/TSGS2_152E_Electronic_2022-08/INBOX/DRAFTS/FS_eNA_Ph3/Draft%C2%A023700-81-040-rm%C2%A0v1.0.docx (accessed on 3 Dec. 2022) hereinafter referred to as “WG2_Arch”). A problem with such an approach, however, may include that the approach may simply result in more data being collected after a particular analytics is produced.

In another approach, a comparison may be performed between predicted outputs of an analytic identifier with a real value, and then an impact on a given KPI may be measured for a given action performed by a NF. See e.g., number 28 discussed in WG2_Arch. A problem with such an approach, however, may include that related associations between NWDAFs, NFs, and KPIs would need to be constructed by hand, which can be time consuming, error-prone, expensive, and non-intuitive in a large setup with multiple NWDAFs and NFs, for example.

Certain aspects of the disclosure and their embodiments may provide solutions to these or other challenges. Rather than a feedback mechanism (as discussed in number 6 of WG2_Arch, for example), operations are provided that can determine correlation and then intervention; and if both properties hold (that is, correlation and intervention), a ML model for a NWDAF can be augmented or created and a NF consumer(s) can subscribe to the augmented or new NWDAF. The operations of some examples include detecting (e.g., identifying) indirect or hidden relevant relationships, and modifying an affected ML model for an NWDAF(s) with additional input features (also referred to herein as “input features” or “features”) or generating a new ML model for NWDAF(s) that takes additional information (e.g., additional input features) into consideration. As a consequence, predictive capability of a NWDAF may be improved to take into consideration an impact of an NF consumer's action.

As discussed further herein, operations can be performed by a computing device that includes a NWDAF function. In non-limiting examples discussed herein, the NWDAF function is referred to as a “NWDAF relationship manager” or “NWDAF_REL_MANAGER”, which can be a logical function that performs operations discussed further herein. It is noted, however, that operations disclosed herein with reference to a NWDAF relationship manager or NWDAF_REL_MANAGER need not be performed by a function having such a name, and may be performed by a computing device that includes, or is communicatively coupled to, a function to perform operations of embodiments disclosed herein.

The function can identify relationships that may exist between data sources, NWDAFs, and/or NFs and can either modify an affected ML model for an NWDAF with additional input features (also referred to herein as input features, inputs, or input data), or generate an augmented ML model for an NWDAF(s) that takes additional input features into consideration.

Certain embodiments may provide one or more of the following technical advantages. Inclusion of a function that can identify relationships and modify dependencies based on a modified or new ML model for one or more NWDAFs may be beneficial to a NWDAF consumer(s) because a newly produced prediction may better capture effects of the NWDAF consumer's action. Thus, an improved prediction may be provided. Additionally, improved prediction may avoid re-triggering an action that was the product of an incorrect or inferior prediction.

A further technical advantage may include that, based on automatic identification of relationships between NWDAFs/NFs, an amount of time and error in making the identification may be reduced in comparison to, e.g., a manual process. Moreover, relationships may be discovered that a manual process may miss due to the existence of non-intuitive relationships, for example.

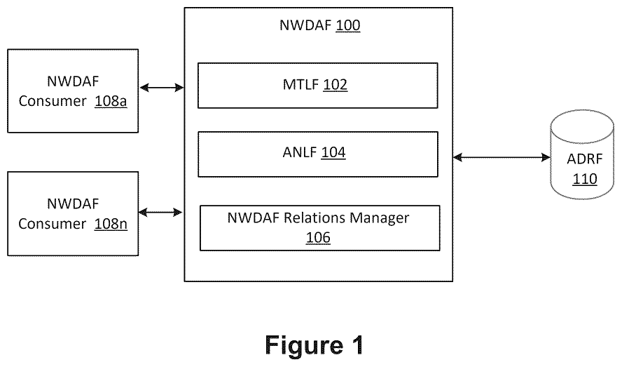

FIG. 1 is a block diagram of components of a system in accordance with some embodiments of the present disclosure. FIG. 1 includes NWDAF 100 communicatively connected to NWDAF consumers 108a, 108n and ADRF 110. ADRF 110 can store data or associated analytics performed on data, and such data or analytics can be retrieved from ADRF 110, in accordance with the present disclosure. NWDAF includes model training logical function (MTLF) 102, analytical logic function (ANLF) 104, and NWDAF relations manager 106. MTLF 102 can be a logical function which trains ML models and exposes new training services (e.g., providing a trained ML model). ANLF 104 can be a logical function which performs inference, derives analytics information (e.g., derives statistics and/or predictions based on an analytics consumer request), and exposes analytics service (e.g., Nnwdaf_AnalyticsSubscription or Nnwdaf_AnalyticsInfo). MTLF 102 and ANLF 104 can include analytics for ML model/inference/training. FIG. 1 further includes one or more NWDAF consumers 108a-108n (any one of which is referred to herein as a “NWDAF consumer 108”), which is communicatively coupled to NWDAF 100.

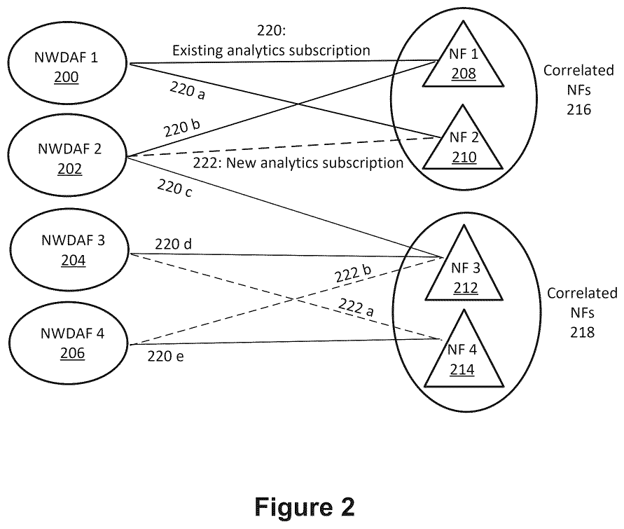

FIG. 2 is a schematic diagram illustrating an example of NWDAFs and NFs that may have relationships. In this example, NWDAF1 200, NWDAF2 202, NWDAF3 204, and NWDAF4 206 are consumed by NF1 208, NF2 210, NF3 212, and NF4 214 as indicated by the respective solid lines 220, 220a, 220b, 220c, 220d, and 220e in FIG. 2. In a setting as illustrated in FIG. 2, two types of relationships are not known: (1) Whether there is any overlap between the input (feature set) between one or more NWDAFs; and (2) for a NF consumer that subscribes to a NWDAF, but does not subscribe to another NWDAF(s), whether the NF consumer may potentially benefit from such a subscription to the other NWDAF(s). The NF consumer may potentially benefit from such a subscription because predictions produced by the unsubscribed NWDAF(s) may be relevant for that NF consumer. Thus, operations of examples of the present disclosure include identifying whether a relationship “line” should exist between NF consumers and NWDAFs that lack a subscription, as illustrated in the example in FIG. 2 by the respective dashed lines 222, 222a, 222b; and/or whether areas of interest should be taken into consideration for the NWDAFs since a hidden relationship (e.g., a relevant relationship) may exist for some areas of interest, but may not exist for other areas of interest.

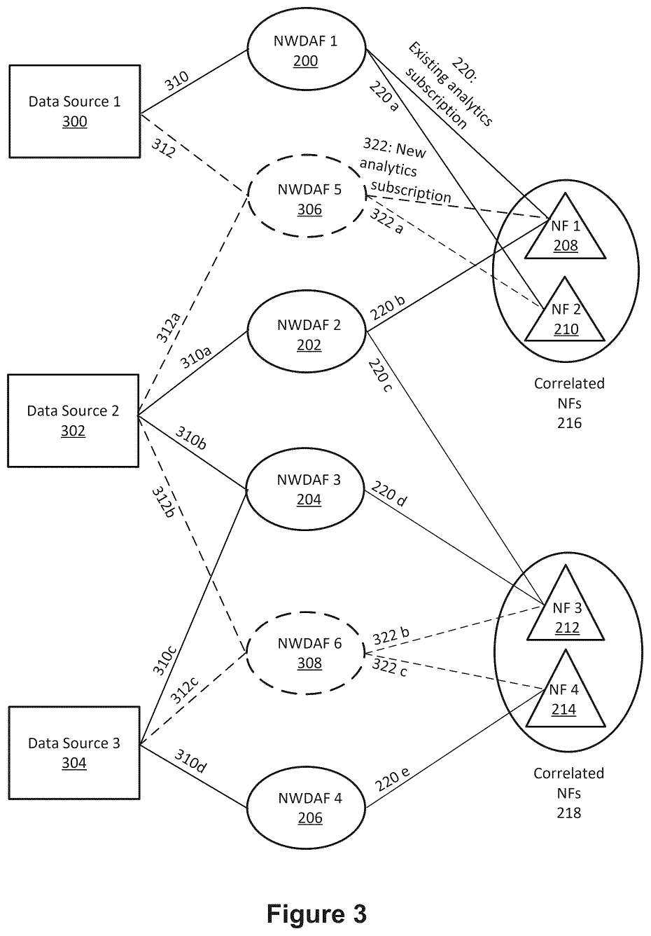

FIG. 3 is a schematic diagram illustrating a further example of the same NWDAFS and NFs shown in FIG. 2, as well as data sources. Thus, the discussion of FIG. 2 is applicable to FIG. 3. FIG. 3, however, further illustrates data source1 300, data source2 302, and data source3 304.

In an example setting as illustrated in FIG. 3, various relationships and information are not known:
(1) Whether there is any overlap between the input (feature set) from data source1 300, data source2 302, and data source3 304 between one or more of NWDAF1 200, NWDAF2 202, NWDAF3 204, and NWDAF2 206;
(2) Whether to modify a ML model of one or more of NWDAF1 200, NWDAF2 202, NWDAF3 204, and NWDAF2 206 with additional features from a data source;
(3) Whether to create a new ML model for one or more NWDAF(s) (e.g., NWDAF5 306 and NWDAF6 308 illustrated with dashed lines in FIG. 3) with additional features from a data source; and/or
(4) For a NF consumer that subscribes to a NWDAF, but does not subscribe to another NWDAF(s), whether the NF consumer may potentially benefit from such a subscription to the other NWDAF(s), including a NWDAFs having a modified or new ML model. The NF consumer may potentially benefit from such a subscription because predictions produced by the unsubscribed modified or ML model or one or more NWDAF(s) may be relevant for that NF consumer.

Thus, operations of examples herein include determining whether a relationship “line” should exist between: (a) NWDAF(s) having a modified or new ML model and a data source based on overlapping input features, as illustrated in the example in FIG. 3 by the respective dashed lines 312, 312a, 312b, 312c; and (b) NF consumers and NWDAFs that lack a subscription or may benefit from a modified or new ML model of an unsubscribed NWDAF(s), as illustrated in the example in FIG. 3 by the respective dashed lines 322, 322a, 322b, 322c; and/or whether (c) areas of interest (aoi) should be taken into consideration for the NWDAFs since a relevant relationship may exist for some areas of interest, but may not exist for other areas of interest. NWDAF5 306 and NWDAF6 308 that respectively include a new ML model can ask the affected NF consumer(s) to subscribe to them.

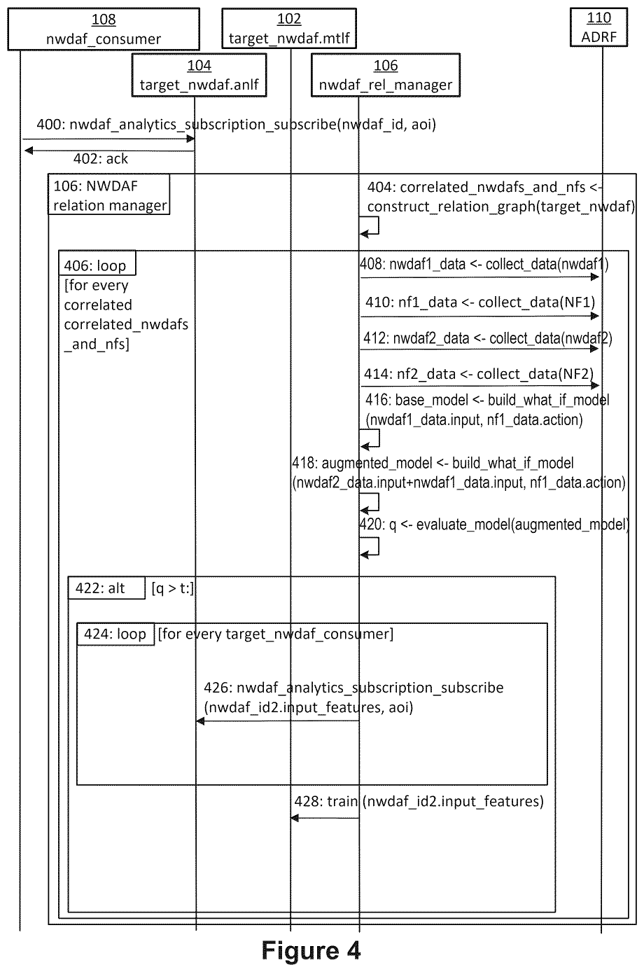

FIG. 4 is a sequence diagram illustrating operations of an example in accordance with the present disclosure. As illustrated in the example of FIG. 3, operations are shown for components that correspond to FIG. 1:
a NWDAF_Consumer 108;
TARGET_NWDAF.ANLF 104, TARGET_NWDAF.MTLF 102, and NWDAF_REL_MANAGER 106 of NWDAF 100; and
ADRF 110.

In the example shown in FIG. 4, NWDAF_REL_MANAGER 106 identifies relationships that may exist between different NF_CONSUMERS and NWDAFs (e.g., between different NWDAFs, data sources, and NF consumers).

In this example, interaction with the NWDAF_REL_MANAGER 106 can take place periodically as indicated in operations 404-428. Initially, and as a bootstrapping operation 400, 402, a set of NWDAF_CONSUMERS 108a-108n are registered with their corresponding TARGET_NWDAF(s). Further in this example, there is a registry that keeps track of such information and that such information is available to the NWDAF_REL_MANAGER 106.

In operation 404, NWDAF_REL_MANAGER 106 constructs a relationship graph of correlated NWDAFs and NFs.

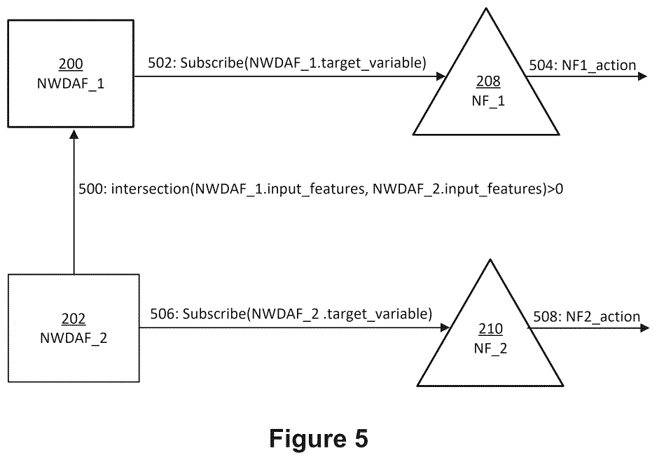

In loop 406, NWDAF_REL_MANAGER 106 performs operations 408-414 and iterates over every pair of the identified, correlated NWDAF/NF that are correlated by way of a feature overlap (e.g., as shown in FIGS. 2, 3). For example, two (or more) NWDAFs overlap if they have common features in their feature space as shown, for example in FIG. 5 discussed further below. If such an overlap exists, then it may make sense to combine the feature space of the ML models of the overlapping NWDAFs as discussed regarding the examples of FIGS. 2, 3.

However, at this stage and referring to FIG. 4, it is not known whether the overlapping NWDAFs should be combined to produce a ML model that classifies whether the output of a first NWDAF (which the NWDAF consumer subscribes to) along with its input triggers an action by the subscribed NF consumer, or does not trigger an action.

Thus, to gain that knowledge, in operation 416, a baseline ML model is trained which learns when a NWDAF consumer triggers an action given the input and output of a first NWDAF that the NWDAF consumer is subscribed to.

Next, in operation 418, the baseline ML model is augmented with additional features from a candidate NWDAF (e.g., NWDAF2 in FIG. 5, discussed further below), and the augmented ML model is trained.

In operation 420, after training the augmented ML model, an analysis q is performed (e.g., a shapley additive explanation (SHAP) analysis or a local interpretable model-agnostic explanation (LIME) analysis) to evaluate the augmented ML model based on measuring the feature importance of the additional features.

If the additional features rank high, in operation 426 of loop 424, NWDAF_REL_MANAGER 106 sends a request to the first NWDAF consumer to subscribe to NWDAF2 as well; or, in operation 428 of loop 422 for each target (t) NWDAF, a new augmented ML model is produced that is the combination of NWDAF1 and NWDAF2.

An example use case is discussed with reference to FIG. 5. If NWDAF_1 200 is responsible for a load level computation and prediction of a network slice, NWDAF_1 200 has a feature set 500 that includes the identity of a network slice and the current load of that slice in different timesteps t0, t1, t2, . . . tn (because in this example, NWDAF_1 200 includes a ML model that handles time series data). The output 502 of NWDAF_1 200 (also referred to as “target_variable” in FIG. 5) can be the load of the slice at tn+1. In the example illustrated in FIG. 2, the output of NWDAF_1 200 is consumed by NF_1 208, and NF_1 208 uses the output 502 of NWDAF_1 200 as input to the prediction of that ML model. NF_1 208 may be performing load balancing, such as moving different functions to different nodes to avoid a high load.

NWDAF_2 202, in this example in FIG. 5, is responsible for predicting congestion 506 and, among other features, NWDAF_2 202 also uses information 500 such as the load of a specific network slice. Thus, the two NWDAFs 200, 202 overlap 500 but that does not necessarily mean that the two NWDAFs 200, 202 may impact each other.

To verify whether the two NWDAFs 200, 202 may impact each other, referring to FIGS. 4 and 5, the NWDAF_REL_MANAGER 106 constructs a base ML model which learns to classify whether the input_features 500 and the output 502 of NWDAF_1 200 may trigger an action 504 or not by NF_1 208 which already subscribes to NWDAF_1 200. If the base ML model has a high enough accuracy, the base ML model is augmented with the additional input features from NWDAF_2 202. A check is performed to determine whether the additional input features affect the classification of the base ML model. If yes, a new ML model m is produced that combines the most important input features of NWDAF_1 200 and NWDAF_2 202.

In another example, a new or augmented ML model trained by the NWDAF_REL_MANAGER 106 can be added into the system as a replacement of the previous ML models and the corresponding subscription(s) is updated.

An example of standardized NWDAF use cases (accessed on 6 Dec. 2022 from https://docs.aws.amazon.com/whitepapers/latest/guavus-5G-iq-nwdaf-on-aws/nwdaf-use-cases.html) and ML models that can be used in examples of the present disclosure are summarized below:

| | Classification ML | |
|---|---|---|
| Use case | Model | Regression ML Model |
| Current and predicted | Binary classification | N/A (while there may be some |
| congestion for a specific | (True: there will be a | measurement of the magnitude |
| location, device, or | congestion, False: | of the congestion, such a |
| group of devices | there will not be | measurement is not appreciated |
| | congestion | in 3GPP) |
| Load analytics | Multi-class depending | [0 . . . 100] |
| information and | on the measure of | |
| prediction for specific | load (10, 20, 30 . . . , | |
| NF instances or types | or low, medium, high) | |
| Network performance | | |
| computation and | | |
| prediction | | |
| Network slice instance | | |
| load level computation | | |
| and prediction | | |
| Quality of service (QoS) | 3 classes: QoS same, | Measurement of QoS |
| sustainability-reporting | QoS decrease, QoS | |
| and predicting QoS | increase | |
| change | | |
| Service experience | 3 classes: Service | Service experience measurement |
| computation and | experience same, QoS | |
| prediction for an | decrease, QoS | |
| application or network | increase | |
| slice | | |
| UE abnormal behavior or | Binary: UE normal, UE | Anomaly magnitude |
| anomaly detection | abnormal | |
| UE mobility analytics and | Used for hand over | If seen as a trajectory prediction |
| expected behavior | purposes: Binary: To | this may yield the next location of |
| prediction | handover a UE to a | the UE. It is noted, however, that |
| | given target cell or not | this use case presently is not |
| | | thoroughly described in the |
| | | standard |

A ML model (e.g., the baseline model and/or augmented model of FIG. 4) for a use case can be either be a classification or regression model as shown in the example use cases in the above table, with variants as noted for respective use cases in the table.

A computer-implemented method is provided that is performed by a computing device including a NWDAF having a function (e.g., NWDAF_Rel_Manager 106) to identify and modify dependencies between one or more NWDAFs and at least a first NWDAF consumer (e.g., NWDAF_Consumer 108).

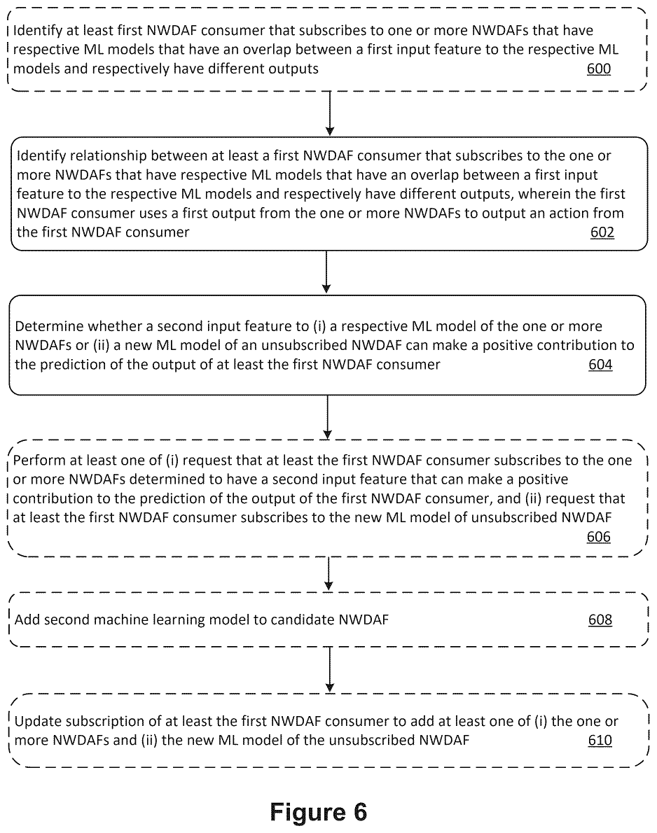

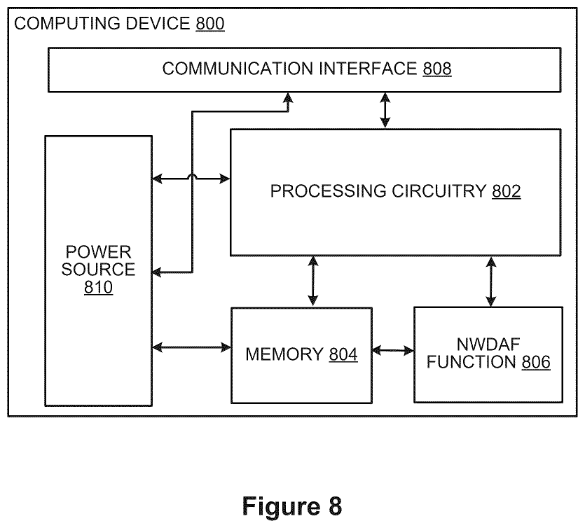

FIG. 6 is a flowchart of operations of a computing device 100, 708 (implemented using the structure of the block diagram of FIG. 8) in accordance with embodiments of the present disclosure. As illustrated in FIG. 6, the computer-implemented method includes identifying (602) a relationship between at least the first NWDAF consumer from a plurality of NWDAF consumers that respectively subscribe to the one or more NWDAFs that have respective ML models that have an overlap between a first input feature to the respective ML models and respectively have different outputs. For example, identifying the relationship can include operation 404 of FIG. 4 and/or operations 500, 502, 506 of FIG. 5). At least the first NWDAF consumer uses a first output from the one or more NWDAFs to output an action from at least the first NWDAF consumer (e.g., as illustrated in example operations 502/504 and 506/508 of FIG. 5). The method further includes determining (604) whether a second input feature to (i) a respective ML model of the one or more NWDAFs or (ii) a new ML model of an unsubscribed NWDAF can make a positive contribution to the prediction of the output of at least the first NWDAF consumer. For example, as discussed with reference to the example of FIG. 4, to determine whether the second input feature can make a positive contribution to the prediction of the output of at least the first NWDAF consumer 108, an analysis q is performed (e.g., a SHAP analysis or a LIME analysis). In a SHAP analysis, for example, a SHAP value from the SHAP analysis can identify how much the second input feature contributed to the respective ML model or new ML model's prediction when compared to a mean prediction. For example, a large positive SHAP value indicates that the second input feature had a positive contribution to the prediction of the output of at least the first NWDAF consumer.

In some embodiments, the at least a first NWDAF consumer includes a NF or an NWDAF.

In some embodiments, the method further includes performing (606) at least one of (i) requesting that at least the first NWDAF consumer subscribes to the one or more NWDAFs determined to have a second input feature that can make a positive contribution to the prediction of the output of at least the first NWDAF consumer, and (ii) requesting that at least the first NWDAF consumer subscribes to the new ML model of the unsubscribed NWDAF. For example, as discussed with reference to FIG. 4, in operation 426 of loop 424, then NWDAF_REL_MANAGER 106 sends a request to the first NWDAF consumer to subscribe to NWDAF2 as well; or, in operation 428, a new augmented ML model is produced that is the combination of NWDAF1 and NWDAF2.

In some embodiments, the method further includes identifying (600) at least the first NWDAF consumer that subscribes to the one or more NWDAFs that have respective ML models that have an overlap between the first input feature and respectively have different outputs. For example, as discussed with reference to the example of FIG. 5, the identification of the overlap between NWDAF_1 200 and NWDAF_2 202 that each use first input feature 500 and respectively have different outputs 504, 508.

In some embodiments, the identifying (602) a relationship is based on a relationship graph (e.g., operation 404 of FIG. 4) of at least the first NWDAF consumer that subscribes to the one or more of the NWDAFs that respectively have the first input feature (e.g., first input feature 500 of FIG. 5) and respectively have different outputs (e.g., outputs 504 and 508 of FIG. 5).

In some embodiments, the determining (604) includes performing an analysis (e.g., operation 420 of FIG. 4) that evaluates a second ML model that uses the first and second input features to associate whether the second input feature of a candidate NWDAF results in the output of the action by at least the first NWDAF consumer; and measuring an importance level of a contribution that the second input feature can make to the prediction of the output of at least the first NWDAF consumer. For example, in a SHAP analysis of operation 420 of FIG. 4, a SHAP value from the SHAP analysis can measure the importance level of a contribution that the second input feature can make to the prediction of the output of at least the first NWDAF consumer. For example, a large positive SHAP value indicates that the second input feature had a positive contribution to the prediction of the output of at least the first NWDAF consumer.

In some embodiments, the relationship includes a relevant relationship and the identifying (602) the relevant relationship includes constructing a graph (e.g., operation 404 of FIG. 4) of relationships between respective NWDAFs from the one or more NWDAFs and at least one of (i) at least the first NWDAF, and (ii) a respective data source from a plurality of data sources that provide the first and second input features to the respective NWDAFs, wherein the graph identifies a relationship between at least one pair of a respective NWDAF and at least the first NWDAF consumer; and iterating (e.g., operations 408-420 of loop 406 of FIG. 4) over the at least one pair of a respective NWDAF and at least the first NWDAF consumer to build a first ML model that learns to associate whether the first input feature of the respective NWDAF results in the prediction of the output of the action by at least the first NWDAF consumer.

In some embodiments, the identifying (602) the relevant relationship further includes building a second ML model (e.g., operation 418 of FIG. 4) comprising the first ML model augmented with the second input feature from a candidate NWDAF in the graph that uses the second input feature as an input to the ML model of the candidate NWDAF, wherein the second ML model learns to associate whether the second input feature of the candidate NWDAF results in the output of the action by at least the first NWDAF consumer.

In some embodiments, determining (604) includes performing an analysis (e.g., operation 420 of FIG. 4) that evaluates the second ML model to measure an importance level of the contribution that the second input feature of the candidate NWDAF can make to the prediction of the output of at least the first NWDAF consumer

In some embodiments, the importance level is determined based on a comparison of a threshold value to the contribution that the second input feature can make to the prediction of the output of at least the first NWDAF consumer (e.g., in the analysis of operation 420 of FIG. 4 (e.g., a SHAP analysis)).

In some embodiments, the importance level is based on one of a shapley additive explanations, SHAP, and a local interpretable model-agnostic explanation, LIME, analysis that measures and ranks an importance of the second input feature.

In some embodiments, when the importance level is not satisfied, the requesting includes that at least the first NWDAF consumer subscribes to the new ML model of the unsubscribed NWDAF (e.g., operation 428 of FIG. 4).

In some embodiments, the method further includes adding (608) the second machine learning model to the candidate NWDAF (e.g., via operation 426 of FIG. 4).

In some embodiments, when the importance level is satisfied, the requesting includes that at least the first NWDAF consumer subscribes to the one or more NWDAFs (e.g., operation 426 of FIG. 4).

In some embodiments, the method further includes updating (610) the subscription of at least the first NWDAF consumer to add at least one of (i) the one or more NWDAFs (e.g., operation 426 of FIG. 4) and (ii) the new ML model of the unsubscribed NWDAF (e.g., operation 428 of FIG. 4).

Operations of a computing device can be performed by the computing device 800 of FIG. 8. Operations of the computing device (implemented using the structure of FIG. 8) have been disclosed with reference to the flow chart of FIG. 6 according to some embodiments of the present disclosure. For example, modules may be stored in memory 804 and/or NWDAF function 806 of FIG. 8, and these modules may provide instructions so that when the instructions of a module are executed by respective computing device processing circuitry 802, computing device 800 performs respective operations of the flow chart.

Various operations from the flow chart of FIG. 6 may be optional with respect to some embodiments of computing devices and related methods. For example, operations of blocks 600 and 606-610 may be optional.

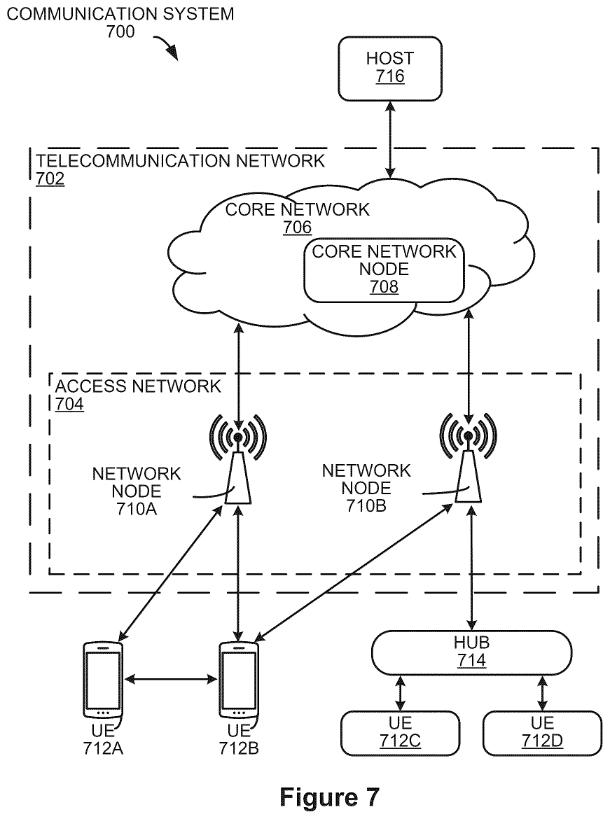

Example embodiments of the methods of the present disclosure may be implemented in a communication system that includes, without limitation, a telecommunication network, as illustrated in FIG. 7. The telecommunications network 702 may include an access network 704, such as a radio access network (RAN), and a core network 706, which includes one or more core network nodes 708. The access network 704 may include one or more access nodes 710A. 710B, such as network nodes (e.g., base stations), or any other similar 3GPP access node or non-3GPP access point. The network nodes 710 facilitate direct or indirect connection of communication devices 712A-D (e.g., a UE), such as by and/or other devices to the core network 706 over one or more wireless connections. Hub 714 communicates with the access network 704 to facilitate indirect communication between one or more UEs (e.g., communication devices 712A and/or 712B) and network nodes (e.g., network node 710B). In some examples, the hub 714 may be a controller, router, content source and analytics, etc. For example, the hub 714 may be a broadband router enabling access to the core network 706 for the communication devices 712A and/or 712B. As another example, the hub 714 may be a controller that sends commands or instructions to one or more actuators in a communication device 712A, 712B.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the network may include any number of wired or wireless networks, network nodes, UEs, and/or any other components or systems that may facilitate or participate in the communication of data and/or signals whether via wired or wireless connections. The network may include and/or interface with any type of communication, telecommunication, data, cellular, radio network, and/or other similar type of system.

As a whole, the communication system 700 enables connectivity between the communication devices 712 and other devices. In that sense, the communication system 700 may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 702 is a cellular network that implements 3GPP standardized features. Accordingly, the telecommunications network 702 may support network slicing to provide different logical networks to different devices that are connected to the telecommunication network. For example, the telecommunications network 702 may provide Ultra Reliable Low Latency Communication (URLLC) services to some communication devices (e.g., UEs), while providing Enhanced Mobile Broadband (eMBB) services to other communication devices, and/or Massive Machine Type Communication (mMTC)/Massive IoT services to yet further communication devices.

In some examples, the communication system 700 is not limited to including a RAN, and rather includes any that includes any programmable/configurable decentralized access point or network element that also records data from performance measurement points in the communication system 700.

FIG. 7 shows a network node 708 in accordance with some embodiments. As used herein, core network node refers to a computing device, equipment capable, configured, arranged and/or operable to communicate directly or indirectly with a computing device and/or with other network nodes, equipment, and data repositories, in a communication system. Examples of network nodes include, but are not limited to, NWDAFs, NFs, mobility management nodes, network operations center nodes, access points (APs) (e.g., radio access points), etc.

Other examples of network nodes include multiple transmission point (multi-TRP) 5G access nodes, transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

FIG. 8 is block diagram of a computing device 800. The computing device 800 includes a processing circuitry 802, a memory 804, a NWDAF function(s) 806, a communication interface 808, and a power source 810. The computing device 800 may be composed of multiple physically or logically separate components (e.g., a NWDAF relation manager function, a NWDAF MTLF, a NWDAF ANLF, etc.). In such embodiments, some components may be duplicated (e.g., separate memory 804 for NWDAF function 806) and some components may be reused (e.g., a same antenna processing circuitry 802 may be shared by memory 804 and NWDAF function 806).

The processing circuitry 802 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other computing device 800 components, such as the memory 804, to provide computing device 800 functionality. In some embodiments, the processing circuitry 802 includes a system on a chip (SOC).

The memory 804 and NWDAF function 806 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 802. The memory 804 and NWDAF function 806 may store any suitable instructions, data, or information, including a computer program, software, an application including one or more of logic, rules, code, tables, and/or other instructions capable of being executed by the processing circuitry 802 and utilized by the computing device 800. The memory 804 and NWDAF function 806 may be used to store any calculations made by the processing circuitry 802 and/or any data received via the communication interface 808. In some embodiments, the processing circuitry 802 and memory 804 is integrated.

The communication interface 808 is used in wired or wireless communication of signaling and/or data between a computing device, a network node, an access network. The communication interface 808 comprises port(s)/terminal(s) to send and receive data, for example to and from a network or other device over a wired or wireless connection. In other embodiments, the communication interface may comprise different components and/or different combinations of components.

The communication interface 808, the processing circuitry 802, the memory 804, and/or the NWDAF function 806 may be configured to perform any receiving operations and/or certain obtaining operations described herein as being performed by the computing device. Any information, data and/or signals may be received from another network node, computing device, device, and/or any other network equipment. Similarly, the communication interface 808, the processing circuitry 802, the memory 804, and/or the NWDAF function 806 may be configured to perform any sending operations described herein as being performed by the computing device. Any information, data and/or signals may be transmitted to another network node, computing device, device, and/or any other network equipment.

The power source 810 provides power to the various components of computing device 800 in a form suitable for the respective components (e.g., at a voltage and current level needed for each respective component). The power source 810 may further comprise, or be coupled to, power management circuitry to supply the components of the computing device 800 with power for performing the functionality described herein. For example, the computing device 800 may be connectable to an external power source (e.g., the power grid, an electricity outlet) via an input circuitry or interface such as an electrical cable, whereby the external power source supplies power to power circuitry of the power source 810. As a further example, the power source 810 may comprise a source of power in the form of a battery or battery pack which is connected to, or integrated in, power circuitry. The battery may provide backup power should the external power source fail.

Embodiments of the computing device 800 may include additional components beyond those shown in FIG. 8 for providing certain aspects of the computing device's functionality, including any of the functionality described herein and/or any functionality necessary to support the subject matter described herein. For example, the computing device 800 may include interface equipment to allow input of information into the computing device 800 and to allow output of information from the computing device 800. This may allow a user to perform diagnostic, maintenance, repair, and other administrative functions for the computing device 800.

The method of the present disclosure is amenable to distributed node and cloud implementation. Various distributed processing options may be used that suit data source, storage, compute, and coordination. For example, data sampling may be done at a computing device, with data analysis, ML model creation, ML model evaluation, etc. performed at the computing device or at a cloud server/node.

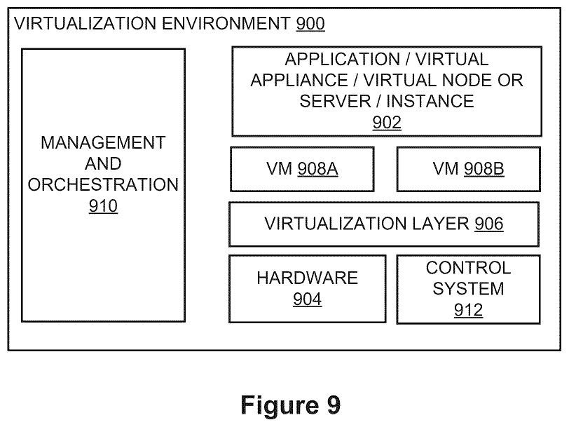

FIG. 9 is a block diagram illustrating a virtualization environment 900 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 900 hosted by one or more of hardware nodes, such as a hardware computing device that operates as a second computing device, or host. Further, in embodiments in which the virtual node does not require radio connectivity (e.g., a core network node or host), then the node may be entirely virtualized.

Applications 902 (which may alternatively be called software instances, virtual appliances, network functions, virtual nodes, virtual network functions, etc.) are run in the virtualization environment 900 to implement some of the features, functions, and/or benefits of some of the embodiments disclosed herein.

Hardware 904 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 906 (also referred to as hypervisors or virtual machine monitors (VMMs)), provide VMs 908a and 908b (one or more of which may be generally referred to as VMs 908), and/or perform any of the functions, features and/or benefits described in relation with some embodiments described herein. The virtualization layer 906 may present a virtual operating platform that appears like networking hardware to the VMs 908.

The VMs 908 comprise virtual processing, virtual memory, virtual networking or interface and virtual storage, and may be run by a corresponding virtualization layer 906. Different embodiments of the instance of a virtual appliance 902 may be implemented on one or more of VMs 908, and the implementations may be made in different ways. Virtualization of the hardware is in some contexts referred to as network function virtualization (NFV or VNF). NFV may be used to consolidate many network equipment types onto industry standard high volume server hardware, physical switches, and physical storage, which can be located in data centers, and customer premise equipment.

In the context of NFV, a VM 908 may be a software implementation of a physical machine that runs programs as if they were executing on a physical, non-virtualized machine. Each of the VMs 908, and that part of hardware 904 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 908 on top of the hardware 904 and corresponds to the application 902.

Hardware 904 may be implemented in a standalone network node with generic or specific components. Hardware 904 may implement some functions via virtualization. Alternatively, hardware 904 may be part of a larger cluster of hardware (e.g. such as in a data center or CPE) where many hardware nodes work together and are managed via management and orchestration 910, which, among others, oversees lifecycle management of applications 902. In some embodiments, hardware 904 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 912 which may alternatively be used for communication between hardware nodes and radio units.

Although the computing device described herein may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the computing device, and/or performing one or more operations based on the obtained information or converted information, and as a result of said processing making a determination. Moreover, while components are depicted as single boxes located within a larger box, or nested within multiple boxes, in practice, first and/or second computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

In the above description of various embodiments of the present disclosure, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus, a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts is to be determined by the broadest permissible interpretation of the present disclosure including the examples of embodiments and their equivalents, and shall not be restricted or limited by the foregoing detailed description.

1. A computer-implemented method performed by a computing device comprising a network data analytics function, NWDAF, having a function to identify and modify dependencies between one or more NWDAFs and at least a first NWDAF consumer, the method comprising:
identifying a relationship between at least the first NWDAF consumer from a plurality of NWDAF consumers that respectively subscribe to the one or more NWDAFs that have respective machine learning, ML, models that have an overlap between a first input feature to the respective ML models and respectively have different outputs, wherein at least the first NWDAF consumer uses a first output from the one or more NWDAFs to output an action from at least the first NWDAF consumer; and
determining whether a second input feature to (i) a respective ML model of the one or more NWDAFs or (ii) a new ML model of an unsubscribed NWDAF can make a positive contribution to the prediction of the output of at least the first NWDAF consumer.

2. The method of claim 1, wherein the at least a first NWDAF consumer comprises a network function, NF, or an NWDAF.

3. The method of claim 1, further comprising:
performing at least one of (i) requesting that at least the first NWDAF consumer subscribes to the one or more NWDAFs determined to have a second input feature that can make a positive contribution to the prediction of the output of at least the first NWDAF consumer, and (ii) requesting that at least the first NWDAF consumer subscribes to the new ML model of the unsubscribed NWDAF.

4. The method of claim 1, further comprising:
identifying at least the first NWDAF consumer that subscribes to the one or more NWDAFs that have respective ML models that have an overlap between the first input feature and respectively have different outputs.

5. The method of claim 4, wherein the identifying a relationship is based on a relationship graph of at least the first NWDAF consumer that subscribes to the one or more of the NWDAFs that respectively have the first input feature and respectively have different outputs.

6. The method of claim 1, wherein the determining comprises
performing an analysis that evaluates a second ML model that uses the first and second input features to associate whether the second input feature of a candidate NWDAF results in the prediction of the output of the action by at least the first NWDAF consumer, and
measuring an importance level of a contribution that the second input feature can make to the prediction of the output of at least the first NWDAF consumer.

7. The method of claim 1, wherein the relationship comprises a relevant relationship and the identifying the relevant relationship comprises:
constructing a graph of relationships between respective NWDAFs from the one or more NWDAFs and at least one of (i) at least the first NWDAF consumer, and (ii) a respective data source from a plurality of data sources that provide the first and second input features to the respective NWDAFs, wherein the graph identifies a relationship between at least one pair of a respective NWDAF and at least the first NWDAF consumer; and
iterating over the at least one pair of a respective NWDAF and at least the first NWDAF consumer to build a first ML model that learns to associate whether the first input feature of the respective NWDAF results in the output of the action by at least the first NWDAF consumer.

8. The method of claim 7, wherein the identifying the relevant relationship further comprises:
building a second ML model comprising the first ML model augmented with the second input feature from a candidate NWDAF in the graph that uses the second input feature as an input to the ML model of the candidate NWDAF, wherein the second ML model learns to associate whether the second input feature of the candidate NWDAF results in the output of the action by at least the first NWDAF consumer.

9. The method of claim 8, wherein the determining comprises performing an analysis that evaluates the second ML model to measure an importance level of the contribution that the second input feature of the candidate NWDAF can make to the prediction of the output of at least the first NWDAF consumer.

10. The method of claim 6, wherein the importance level is determined based on a comparison of a threshold value to the contribution that the second input feature can make to the prediction of the output of at least the first NWDAF consumer.

11. The method of claim 6, wherein the importance level is based on one of a shapley additive explanations, SHAP, and a local interpretable model-agnostic explanation, LIME, analysis that measures and ranks an importance of the second input feature.

12. The method of claim 3, wherein when the importance level is not satisfied, the requesting comprises that at least the first NWDAF consumer subscribes to the new ML model of the unsubscribed NWDAF.

13. The method of claim 12, further comprising:
adding the second machine learning model to the candidate NWDAF.

14. The method of claim 3, wherein when the importance level is satisfied, the requesting comprises that at least the first NWDAF consumer subscribes to the one or more NWDAFs.

15. The method of claim 3, further comprising:
updating the subscription of at least the first NWDAF consumer to add at least one of (i) the one or more NWDAFs and (ii) the new ML model of the unsubscribed NWDAF.

16. A computing device comprising a network data analytics function, NWDAF, having a function to identify and modify dependencies between one or more NWDAFs and at least a first NWDAF consumer, the computing device comprising:
processing circuitry;
memory coupled with the processing circuitry, wherein the memory includes instructions that when executed by the processing circuitry causes the computing device to perform operations comprising:
identify a relationship between at least the first NWDAF consumer from a plurality of NWDAF consumers that respectively subscribe to the one or more NWDAFs that have respective machine learning, ML, models that have an overlap between a first input feature to the respective ML models and respectively have different outputs, wherein at least the first NWDAF consumer uses a first output from the one or more NWDAFs to output an action from at least the first NWDAF consumer; and
determine whether a second input feature to (i) a respective ML model of the one or more NWDAFs or (ii) a new ML model of an unsubscribed NWDAF can make a positive contribution to the prediction of the output of at least the first NWDAF consumer.

17. The computing device of claim 16, wherein the at least a first NWDAF consumer comprises a network function, NF, or an NWDAF.

18.-21. (canceled)

22. A computer program product comprising a non-transitory storage medium including program code to be executed by processing circuitry of a computing device comprising a network data analytics function, NWDAF, having a function to identify and modify dependencies between one or more NWDAFs and at least a first NWDAF consumer, whereby execution of the program code causes the computing device to perform operations comprising:
identify a relationship between at least the first NWDAF consumer from a plurality of NWDAF consumers that respectively subscribe to the one or more NWDAFs that have respective machine learning, ML, models that have an overlap between a first input feature to the respective ML models and respectively have different outputs, wherein at least the first NWDAF consumer uses a first output from the one or more NWDAFs to output an action from at least the first NWDAF consumer; and
determine whether a second input feature to (i) a respective ML model of the one or more NWDAFs or (ii) a new ML model of an unsubscribed NWDAF can make a positive contribution to the prediction of the output of at least the first NWDAF consumer.

23. The computer program product of claim 22, wherein the at least a first NWDAF consumer comprises a network function, NF, or an NWDAF.

24. The computing device of claim 16, wherein the memory includes instructions that when executed by the processing circuitry causes the computing device to perform further operations comprising:
performing at least one of (i) requesting that at least the first NWDAF consumer subscribes to the one or more NWDAFs determined to have a second input feature that can make a positive contribution to the prediction of the output of at least the first NWDAF consumer, and (ii) requesting that at least the first NWDAF consumer subscribes to the new ML model of the unsubscribed NWDAF.
